(19) United States
(12) Patent Application Publication
(10) Pub. No.: US 2003/0023982 A1
(43) Pub. Date: Jan. 30, 2003

(54) Scalable video encoding/storage/distribution/decoding for symmetrical multiple video processors

(76) Inventors: Tsu-Chang Lee, Los Altos, CA (US); Hsi-Sheng Chen, Fremont, CA (US); Song H. An, San Diego, CA (US)

Correspondence Address: OKAMOTO & BENEDICTO, LLP, P.O. BOX 641330, SAN JOSE, CA, 95164, US

(21) Appl. No.: 10/150,891

(22) Filed: May 17, 2002

Related U.S. Application Data
(60) Provisional application No. 60/291,910, filed on May 18, 2001.

(51) Int. Cl. H04N 7/173; H04N 7/16

(52) U.S. Cl. 725/116; 725/138; 725/146

(57) ABSTRACT

An apparatus in a transmit-side stage in a video distribution system, includes: a video decomposer capable to partition a video stream into a plurality of component video streams; a transmit-side processor pool capable to process the component video streams; a partition compensation circuit capable to generate a partition compensation bit stream for distribution along with the compressed bit streams of the component video streams; a marker stage capable to mark the compressed component video streams prior to storage or distribution to a transmission media; and a selection circuit capable to transmit the component video streams for transmission across the transmission media or for storage in a storage device. An apparatus in receive-side stage in a video distribution system, includes: a de-multiplexer and de-marker stage capable to sort component video streams received from a transmission media; a receive-side processor pool capable to process the component video streams; and a video composer capable to re-construct original video stream from the component video streams and the partition compensation bit stream.

### CROSS-REFERENCE TO RELATED APPLICATION

This application claims priority to and the benefit of U.S. Provisional Application No. 60/291,910, by common inventors, Tsu-Chang Lee, Hsi-Sheng Chen, and Song Howard An, filed May 18, 2001, and entitled “SCALABLE VIDEO ENCODING/STORAGE/DISTRIBUTION/DECODING FOR SYMMETRICAL MULTIPLE VIDEO PROCESSORS”. Application No. 60/291,910 is fully incorporated herein by reference.

### TECHNICAL FIELD

Embodiments of the invention relate generally to data encoding, storage, distribution, and decoding, and more particularly but not exclusively, to data encoding, storage, distribution, and decoding by use of symmetrical multiple processors.

### BACKGROUND

Presently, data (e.g., video data, voice data, images, or other data) are being transmitted over the Internet or other communications networks for various applications. Improving the scalability of networks that transmit data is an important issue that needs to be addressed. Users are now accessing the Internet (or other communications networks) by use of various devices such as, for example, phone lines, cellular phone networks, cable lines, or digital subscriber lines (DSL). By improving the scalability of the networks, users can easily send and/or receive data via the Internet or other communications networks. However, current approaches and/or technologies are limited to particular capabilities and suffer from various constraints.

Another important issue that needs to be addressed is to permit the network-transmitted data to be more error resilient. When data is transmitted over a communications channel, there may be errors due to, for example, signal interference, noise, and missing data as a result of the transmission, and/or data latency. In some real-time applications (e.g., video conferencing applications), it is desirable to perform error corrections in a fast manner so that the quality of service across the communications channel is not compromised. However, current approaches and/or technologies are limited to particular capabilities and suffer from various constraints.

Accordingly, there is a business and/or commercial need for a new system, apparatus, and/or method to improve the scalability for networks that transmit data. There is also a business and/or commercial need for a new system, apparatus, and/or method that will permit network-transmitted data to be more error resilient.

### SUMMARY OF EMBODIMENTS OF THE INVENTION

In an embodiment of the present invention, an apparatus for distributing data, includes: a pool of symmetrical processors capable to encode or decode parallel video streams simultaneously; and a parallel processing control unit capable to generate processor control signals and settings, based on at least some of video encoding or decoding requirements, status of video streams, and status of multiple processors in the pool, to facilitate the coordination among multiple processors in the pool to effectively encode or decode the video streams to achieve high quality and high performance targets.

In another embodiment, an apparatus in a transmit-side stage in a video distribution system, includes: a video decomposer capable to partition a video stream into a plurality of component video streams; a transmit-side processor pool capable to process the component video streams; a partition compensation circuit capable to generate a partition compensation bit stream for distribution along with the compressed bit streams of the component video streams; a marker stage capable to mark the compressed component video streams prior to storage or distribution to a transmission media; and a selection circuit capable to transmit the component video streams for transmission across the transmission media or for storage in a storage device.

In another embodiment, an apparatus in receive-side stage in a video distribution system, includes: a de-multiplexer and de-marker stage capable to sort component video streams received from a transmission media; a receive-side processor pool capable to process the component video streams; and a video composer capable to re-construct original video stream from the component video streams and the partition compensation bit stream.

In another embodiment, a video distribution apparatus for distributing bit streams, includes: a single video source capable to generate component video streams and a partition compensation stream; and a processor capable to select a subset of the component video streams fulfilling at least some of quality, resolution, frame rate requested, and channel bandwidth, error, delay characteristics.

In another embodiment, a method of transmitting data, includes: decomposing a digital video signal into component video streams; encoding the component video streams to generate encoded component video streams; generating a difference between the original digital video signal and the encoded component video streams that are locally reconstructed; marking the encoded component video streams to specify at least one of the following: (1) the relationship between the encoded component video streams; (2) the relative location of encoded component video streams that are stored in video storage device; and (3) information relating to a transmission media (e.g., communications channels) that transmit the encoded component video streams; and permitting the encoded component video streams to be stored or separately transmitted via the transmission media.

In yet another embodiment, a method of receiving data, includes: receiving encoded component video streams via a transmission media; performing an inverse marking function that includes at least one of the following: (1) performing error compensation functions; (2) assigning the encoded component video streams to an associated processor for decoding; and (3) providing control information to a video composer to recover the original video data, even if some component video streams are missing; decoding the encoded component video streams; and composing the decoded component video streams into the recovered digital video stream.

In yet another embodiment, an apparatus for transmitting data, includes: means for decomposing a digital video signal into component video streams; coupled to the decomposing means, means for encoding the component video streams to generate encoded component video streams; coupled to the encoding means, means for generating a difference between the original digital video signal and the encoded component video streams that are locally reconstructed; coupled to the generating means, means for marking the encoded component video streams to specify at least one of the following: (1) the relationship between the encoded component video streams; (2) the relative location of encoded component video streams that are stored in video storage device; and (3) information relating to a transmission media that transmit the encoded component video streams; and coupled to the marking means, means for permitting the encoded component video streams to be stored or separately transmitted via a transmission media.

In yet another embodiment, an apparatus for of receiving data, includes: means for receiving encoded component video streams via a transmission media; coupled to the receiving means, means for performing an inverse marking function that includes at least one of the following: (1) performing error compensation functions; (2) assigning the encoded component video streams to an associated processor for decoding; and (3) providing control information to a video composer to recover the original video data, even if some component video streams are missing; coupled to the performing means, means for decoding the encoded component video streams; and coupled to the decoding means, means for composing the decoded component video streams into the recovered digital video stream.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is block diagram of a video transmission system, in accordance with a specific embodiment of the invention.

FIG. 2A is a block diagram showing examples of various methods of decomposing a video stream, in accordance with at least one embodiment of the invention.

FIG. 2B is a block diagram showing an example of a method of decomposing a video stream by a combination of spatial interleaving and temporal interleaving, in accordance with an embodiment of the invention.

FIG. 2C is a block diagram showing an example of a method of decomposing a video stream by a combination of spatial interleaving and temporal region based decomposition, in accordance with an embodiment of the invention.

FIG. 2D is a block diagram showing an example of a method of decomposing a video stream by a combination of spatial region based decomposition and temporal interleaving, in accordance with an embodiment of the invention.

FIG. 2E is a block diagram showing an example of a method of decomposing a video stream by a combination of spatial region based decomposition and temporal region based decomposition, in accordance with an embodiment of the invention.

FIG. 3 is a block diagram that illustrates additional functions of an embodiment of the transmit-side components (formed by a video decomposer, transmit-side processor pool, and partition compensation circuit and marker stage).

FIG. 4 is a block diagram illustrating an apparatus for performing a partition compensation scheme used to smooth out the boundary conditions, in accordance with an embodiment of the invention.

FIG. 5 are diagrams illustrating smoothing and direct cosine transform (DCT) methods according to an embodiment of the invention.

FIG. 6 is a diagram illustrating a method of decomposing a video, in accordance with an embodiment of the invention.

FIG. 7 are block diagrams of frames that are partitioned into lower resolution component frames at a given time t, in accordance with an embodiment of the invention.

FIG. 8 is a block diagram of some of the transmit-side stages shown for the purpose of describing the scalability scheme of an embodiment of the invention.

FIG. 9 is block diagram illustrating additional details and functions of the receiver-side stages (formed by the de-multiplexer and de-marker stage, receiver-side processor pool and video composer), in embodiment of the present invention.

FIG. 10 are block diagrams illustrating examples of error recovery methods according to at least an embodiment of the invention.

FIG. 11 is a block diagram illustrating a method of video streaming or distribution according to an embodiment of the invention.

FIG. 12 is a block diagram showing functional aspects of the video streaming or distribution method of FIG. 11, in accordance with an embodiment of the invention.

FIG. 13 is a block diagram illustrating additional details of the stages in the transmit-side of the system of FIG. 1, in accordance with an embodiment of the invention.

FIG. 14 shows various timing diagrams for odd and even video frames that are processed in the video composer of FIG. 1, in accordance with an embodiment of the invention.

FIG. 15 is a block diagram illustrating additional details of the stages in the receive-side of the system of FIG. 1, in accordance with an embodiment of the invention.

FIG. 16 is a block diagram of a video assembler for performing video reconstruction due to errors, in accordance with an embodiment of the invention.

FIG. 17 is a flowchart illustrating a method of transmitting data, in accordance with an embodiment of the invention.

FIG. 18 is a flowchart illustrating a method of receiving data, accordance with an embodiment of the invention.

### DETAILED DESCRIPTION OF PREFERRED EMBODIMENTS

In the description herein, numerous specific details are provided, such as the description of system components and methods, to provide a thorough understanding of embodiments of the invention. One skilled in the relevant art will recognize, however, that the invention can be practiced without one or more of the specific details, or with other systems, methods, components, materials, parts, and the like. In other instances, well-known structures, materials, or operations are not shown or described in detail to avoid obscuring aspects of the invention.

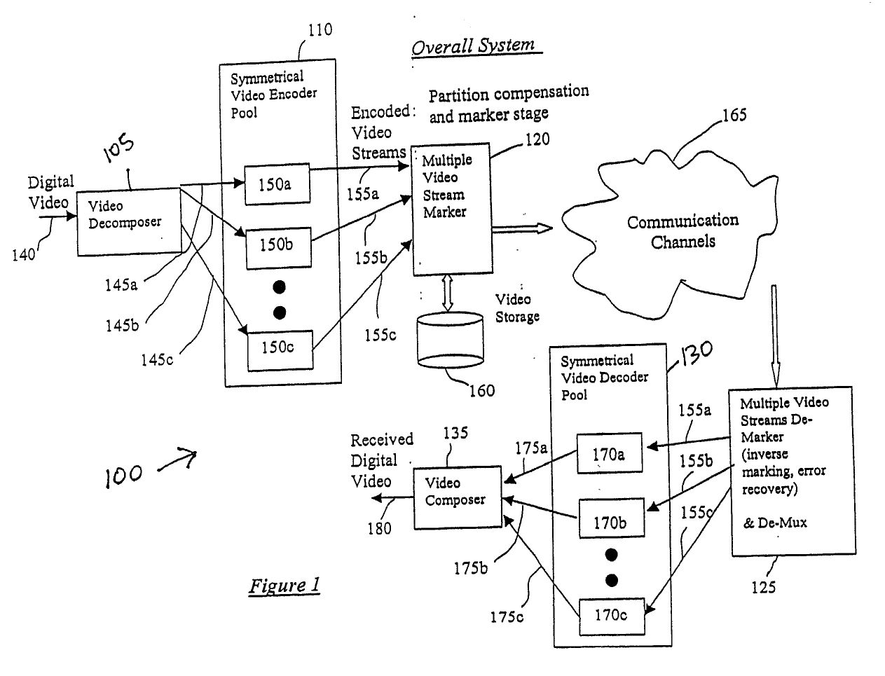

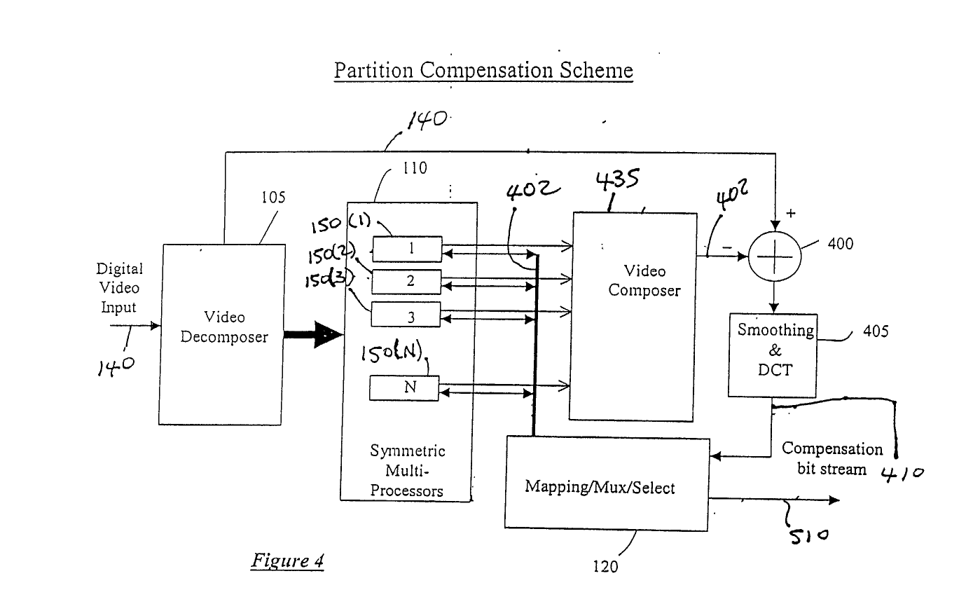

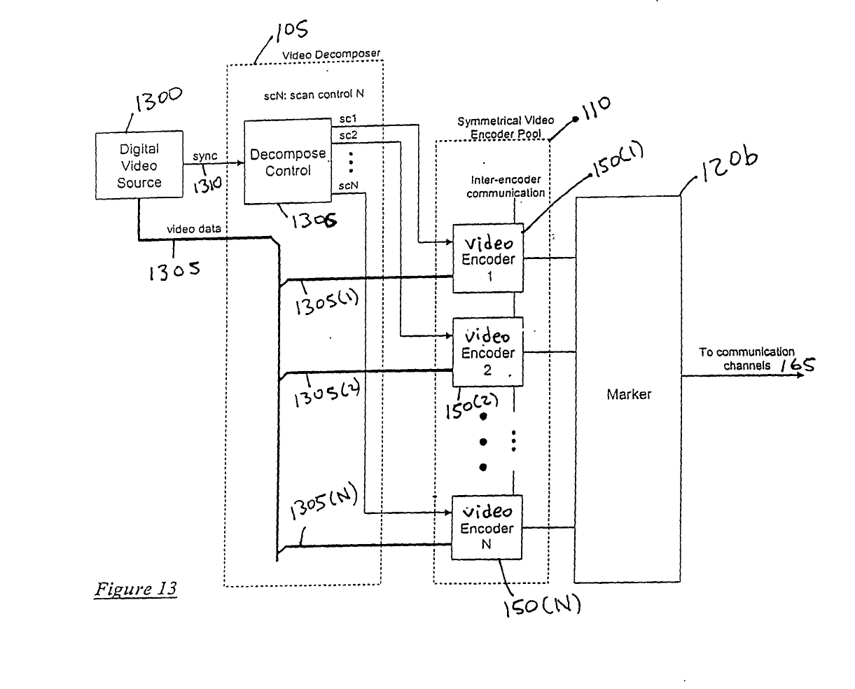

FIG. 1 is block diagram of a data transmission system (or apparatus) 100 in accordance with a specific embodiment of the invention. The processing system 100 includes a symmetric multi-processor architecture as described below in detail. The processing system 100 enables truly scalable bit streams for media storage and distributions. Thus, the processing system 100 permits the streaming of media or other data for various channel bandwidths. It is noted that other embodiments of the invention permits the processing of other types of data (e.g., voice, text, and/or other data) and are not limited to video processing. In an embodiment, the system 100 includes a video decomposer 105, symmetrical video encoder pool 110 (i.e., transmit-side processor pool 110), partition compensation circuit and marker (transmit-side parallel processing control unit) 120, multiple video stream de-marker and de-multiplexer stage (receive-side parallel processing control unit) 125, symmetrical video decoder pool 130 (or receiver-side processor pool 130), and video composer 135. It is noted that the partition compensation circuit is shown as stages 400 and 405 in FIG. 4 and generates partition compensation bit stream 410 to be generated. The marker 120b is shown in FIG. 13.

Of course, the system 100 is not limited to video processing applications. Therefore, the video decomposer 105 may be another type of data decomposer and may be a flexible decomposer tailored for different applications. Similarly, the video composer 135 may be another type of data composer. The processor pools 110 and 130 are not limited to video encoders or video decoders and may be other types of data processors. The partition compensation circuit and marker stage 120 is similarly not limited to the processing of video data and may process other types of data. The de-marker and de-multiplexer stage 125 is similarly not limited to the processing of video data and may process other types of data as well.

The video decomposer 105 is capable to decompose an uncompressed input digital video stream 140 into a plurality of component video streams to feed into a group of symmetrical video processors 150 in the processor pool 110. In the example shown in FIG. 1, the video component streams are shown as component video streams 145a, 145b, and 145c, as described further below. The number of component video streams 145 may vary depending on, for example, the particular implementation. In one embodiment, the processor pool 110 includes multiple processors 150a, 150b, and 150c for processing component video streams 145a, 145b, and 145c, respectively. The number of processors 150 in the processor pool 110 may vary. Each of the processors 150a, 150b, and 150c generates encoded (compressed) video streams 155a, 155b, and 155c, respectively. Thus, a particular processor 150 can process a particular component video stream 145, where the particular component video stream 145 may have a lower frame rate and resolution.

In an embodiment, the processor pool 110 also permits synchronization of the processed signals (encoded component video streams).

The partition compensation and marker stage 120 generates the difference of the original video and the locally reconstructed video from the outputs of the processor pool 110. This fine, but much reduced video information, will be stored and/or distributed along with the compressed video streams. The marker 120b (FIG. 13) in stage 120 marks information in the encoded component video streams 155a, 155b, and 155c to specify one or more of the following: (1) the relationship between the different video streams 155a, 155b, and 155c; (2) the relative location of encoded video streams 155a, 155b, and 155c that are stored in video storage device 160; and/or (3) information relating to communications channels 165. The above-information as marked by the stage 120 marker permits the network-transmitted data to be more error resilient, and this information can include error resilient information to make the video streams more resilient to channel noise and interference.

As discussed above, each decomposed video component 145 will be encoded using a pool 110 of the same type symmetrical video processors 150 and marked by the marker 120b about the relative location in the combined video.

The multiple component video streams 155a to 155c can be stored in the storage device 160 or separately transmitted via a transmission media (e.g., communication channels 165). Based on the channel bandwidth and storage capacity, a plurality of video components can be deployed to be suitable for the channel and storage conditions. This can be used to implement a highly scalable video streaming solution to cover a wide range of wide bandwidth and storage requests based on a uniform or less complex representation.

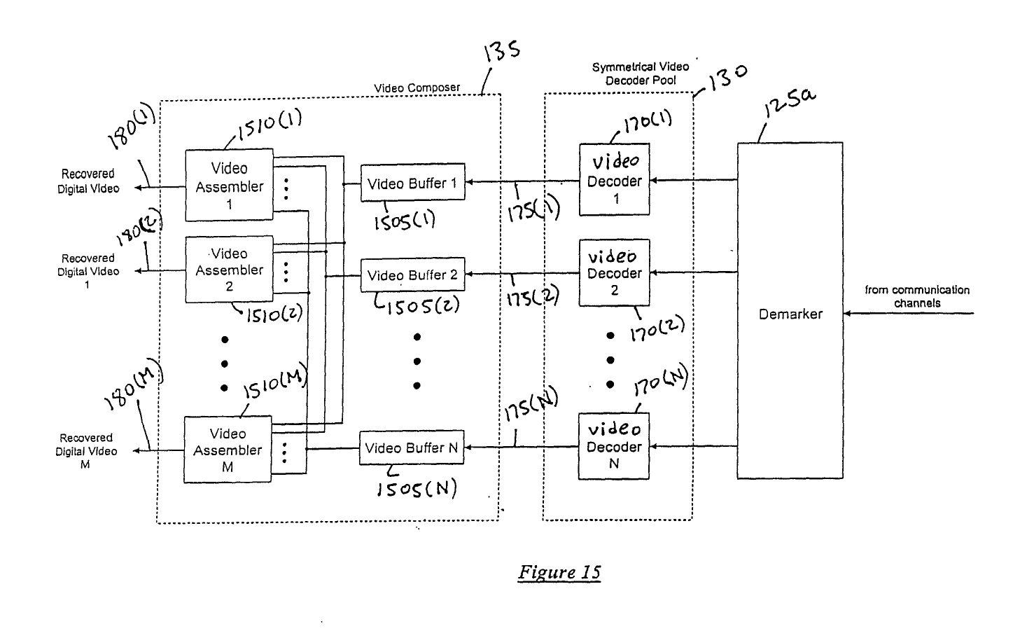

The de-marker 125a (FIG. 15) in stage 125 retrieves the transmitted compressed video streams 155a, 155b, 155c (and a partition compensation bit stream 410 in FIG. 4) to perform an inverse marking function on the video streams 155a-155c. The de-marker 125a in stage 125 peels off marker information from multiple encoded video components. The de-marker 125a can also use the marker information to perform error compensation functions. The de-marker 125a can also assign the video component streams 155a-155c to associated decoders 170a-17c in the symmetrical decoder pool 130 for decompression. The de-marker 125a can also provide control information to the video composer 135 to recover the original video stream 140 as digital video stream 180, even if some video component streams are missing. As noted above, the system 100 may, additionally or alternatively, receive other data types as input stream 140 and output the received stream as output stream 180.

In one embodiment, the processor pool 130 includes multiple processors 170a, 170b, and 170c for processing component video streams 155a, 155b, and 155c, respectively. The number of processors 170 in the decoder pool 130 may vary depending on, for example, the particular implementation. Each of the processors 170a, 170b, and 170c generates decoded (decompressed) video streams 175a, 175b, and 175c, respectively.

The video composer 135 is capable to compose the decompressed component video streams 175a, 175b, and 175a into the recovered digital video stream 180. The video composer 135 combines decoded video component streams 175a-175c together as well as the partition compensation bit stream 410 (FIG. 4) to reproduce the original high resolution input video stream. The video composer 135 can also fill in the missing video component stream or missing portion of the inside of a video component by use of spatial/temporal interpolation or inference methods in order to recover the original information in the input video stream 140. Data may be missing from the video stream received by the de-marker 125a in stage 125 or the received video stream may have an error, due to channel noise or interference. Thus, the video composer 135 can perform error compensation when generating the digital video stream 180, for example, if at least one of the decompressed component video streams 175a-175c has an error due to channel noise or interference, if a portion of the inside of at least one of the component video streams 175a-175c is missing, and/or if one of the component video streams 175a-175c is missing.

Thus, in an embodiment, the symmetrical multiple video processor system 100, includes: a pool 110 of transmit-side symmetrical processors 150a-150c capable to encode parallel video streams 145a-145c simultaneously; a pool 130 of receive-side symmetrical processors 170a-170c capable to decode parallel video streams 155a-155c simultaneously; a processing control unit 120 capable to generate processor control signals and settings, based on at least some of video encoding requirements, status of video streams 155a-155c, and status of multiple processors 150a-150c in the pool 110, to facilitate the coordination among multiple processors 150a-150c in the pool 110 to effectively encode the video streams 155a-155c to achieve high quality and high performance targets; another processing control unit 125 capable to generate processor control signals and settings, based on at least some of video decoding requirements, status of video streams 155a-155c, and status of multiple processors 170a-170c in the pool 130, to facilitate the coordination among multiple processors 170a-170c in the pool 130 to effectively decode the video streams 155a-155c to achieve high quality and high performance targets. In an embodiment, a transmit-side processor 150 in the pool 110 is capable to select a subset of the component video streams fulfilling at least some of quality, resolution, frame rate requested, and channel bandwidth, error, delay characteristics.

As described in additional details below, the apparatus 100 enables the processing of truly scalable bit streams for media storage and/or distribution. This permits, for example, scalable resolution/frame-rate/bit-rate media streaming for various channel bandwidths under a simple uniform data representation and processing architecture using the same media storage capacity. Additionally, the apparatus 100 is error resilient. In other words, the apparatus 100 can compensate for error occurrence in data transmission, as described below.

One example of an application of the apparatus 100 is capturing the video of live events such as, for example, sport events or concerts. A camera would capture the event on video and generate an analog video signal that is converted into a digital video signal 140. The video of the event can be stored in the video storage device 160 or transmitted via a data communications network 165 (e.g., the Internet) as a live broadcast that can be seen via a receiving device such as a personal computer, set top box, digital TV, personal digital assistant, cellular phone or other suitable devices. The channel bit rate and/or resolution may differ for a receiving device, depending on the type of receiving device.

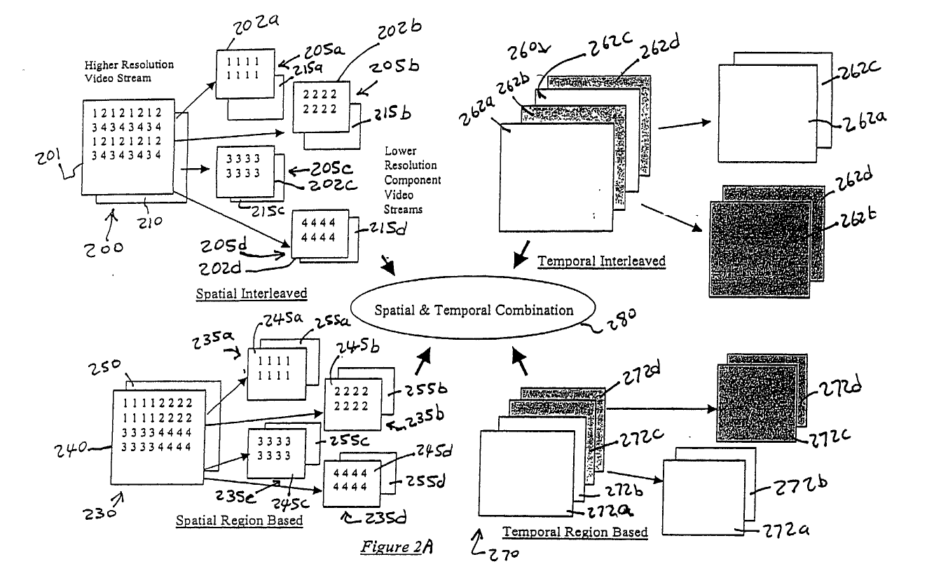

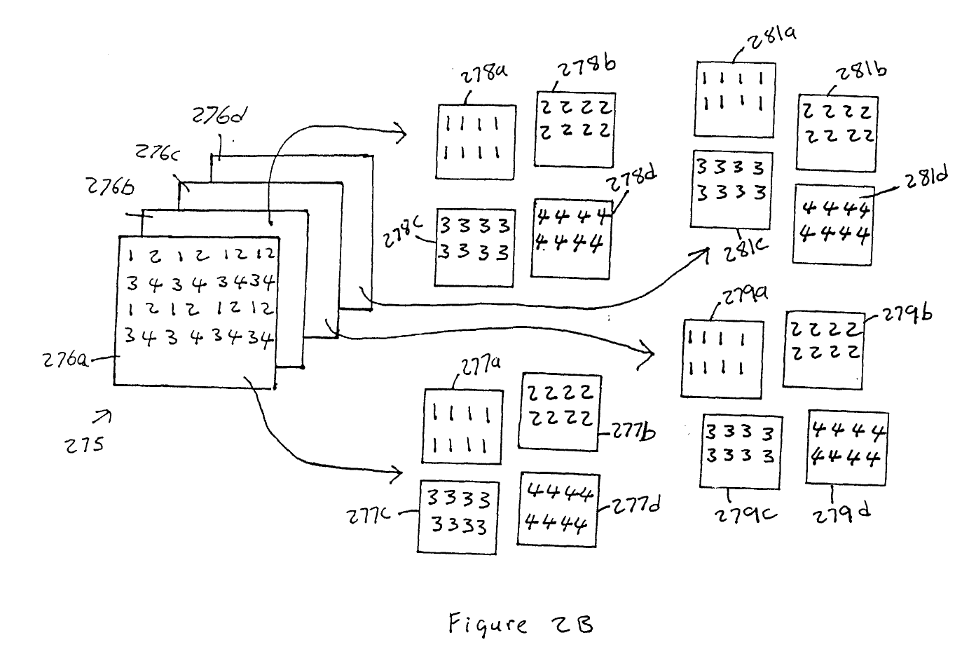

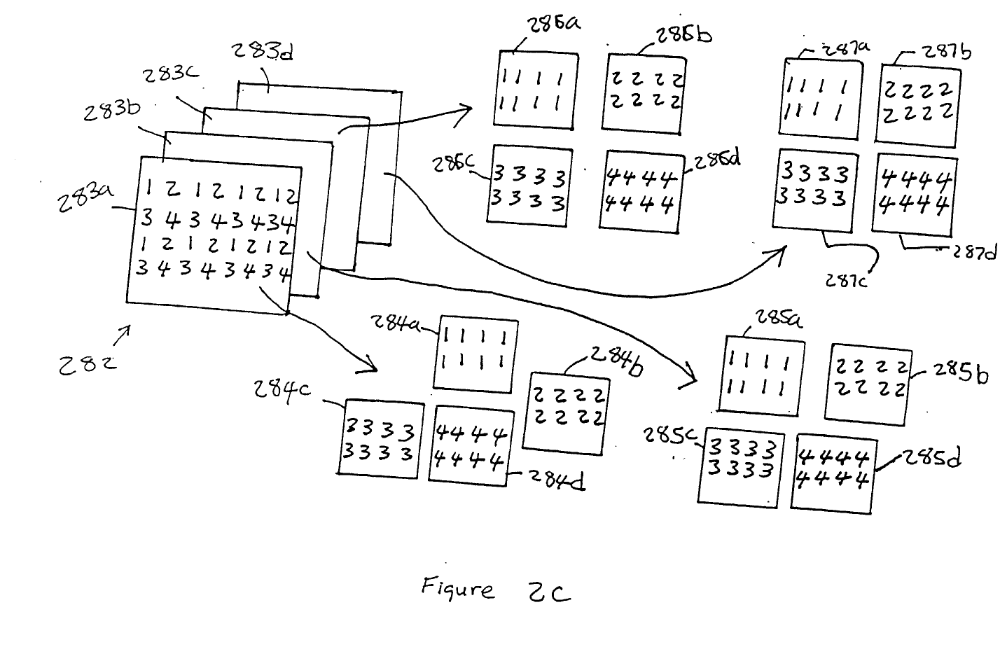

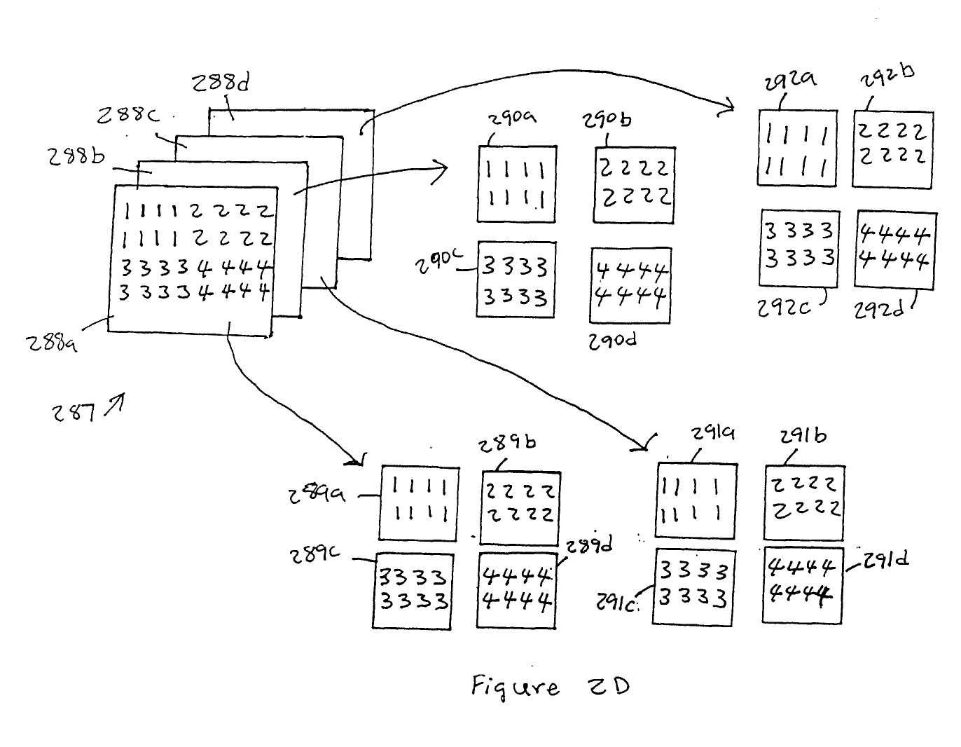

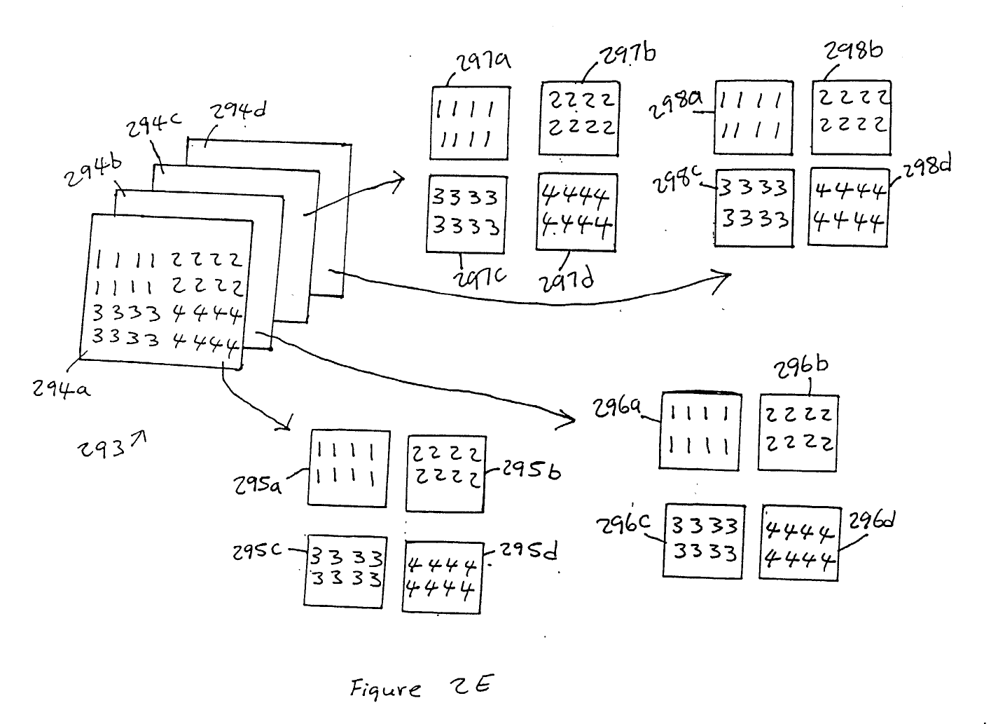

FIG. 2A is a block diagram showing examples of various methods of decomposing a video stream, in accordance with at least one specific embodiment of the invention. A higher resolution video stream 200 can be decomposed (by video decomposer 105) into, for example, multiple lower resolution component video streams 205a, 205b, 205c, and 205d by spatial interleaving. The number of lower resolution component video streams 205 may vary. Each component video stream 205 still shows the entire picture, but has a coarser appearance. For example, one component video stream may include particular pixel values at coordinates (i,j) of a frame, while another component video stream may include other particular pixel values at other coordinates of the same frame. In the example of FIG. 2A, the frame 202a of the component video stream 205a includes pixel values at coordinates labeled as “1” of frame 201 of video stream 200, where each coordinate “1” has different (i,j) values. The frame 202b of the component video stream 205b includes pixel values at coordinates labeled as “2” of frame 201, where each coordinate “2” has different (i,j) values. The frame 202c of the component video stream 205c includes pixel values at coordinates labeled as “3” of frame 201, where each coordinate “3” has different (i,j) values. The frame 202d of the component video stream 205d includes pixel values at coordinates labeled as “4” of frame 201, where each coordinate “4” has different (i,j) values. Subsequent frames at subsequent time(s) t are also decomposed in the same manner. For example, subsequent frame 210 of the higher resolution video stream 200 can be decomposed into the component video stream frames 215a, 215b, 215c, and 215d in the same manner as described above. The component video stream frames 215a, 215b, 215c, and 215d are processed by, for example, processors 150(1), 150(2), 150(3), and 150(4), respectively, in the processor pool 110.

A higher resolution video stream 230 can also be decomposed (by video decomposer 105) into, for example, multiple lower resolution video streams 235a, 235b, 235c, and 235d, based spatial region. The number of lower resolution component video streams 235 may vary. For example, a frame 240 may be decomposed into multiple component video stream frames 245a, 245b, 245c, and 245d, where each component video stream frame 245 includes particular pixel values at a defined frame region. In the example of FIG. 2A, the frame 245a of the component video stream 235a includes pixel values at coordinates labeled as “1” in a spatial region of frame 240 of video stream 230. The size and or shape of a spatial region in a frame of video stream 230 may vary. The frame 245b of the component video stream 235b includes pixel values at coordinates labeled as “2” in another spatial region of frame 240 of video stream 230. The frame 245c of the component video stream 235c includes pixel values at coordinates labeled as “3” in another spatial region of frame 240 of video stream 230. The frame 245d of the component video stream 235d includes pixel values at coordinates labeled as “4” in another spatial region of frame 240 of video stream 230. Subsequent frames at subsequent time(s) t are also decomposed in the same manner. For example, subsequent frame 250 of the higher resolution video stream 230 can be decomposed into the frames 255a, 255b, 255c, and 255d in the same manner as described above. The component video stream frames 245a, 245b, 245c, and 245d are processed by, for example, processors 150(1), 150(2), 150(3), and 150(4), respectively, in the processor pool 110.

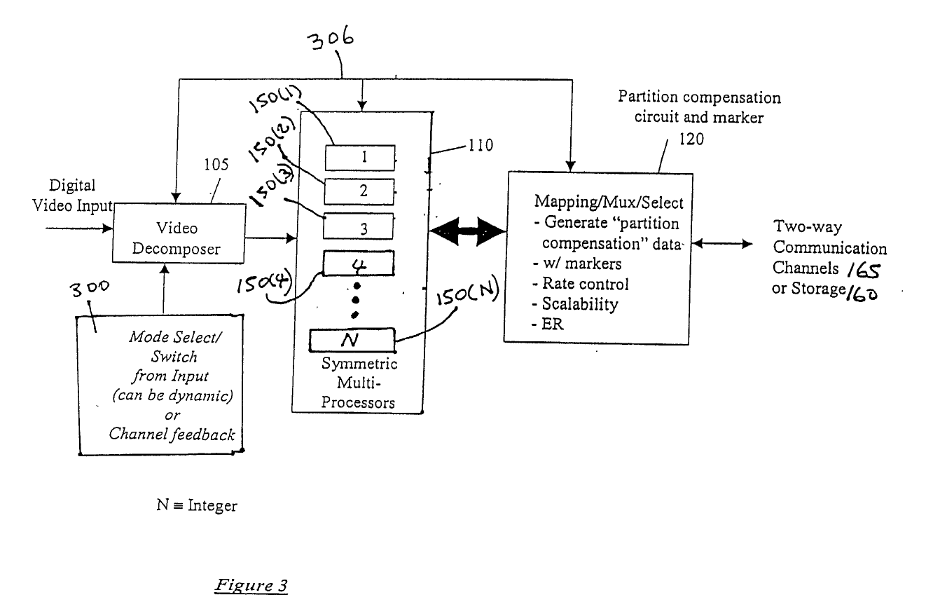

A higher resolution video stream 260 can also be separated (or decomposed) into, for example, multiple lower resolution video streams by temporal interleaving. Each frame 262a, 262b, 262c, and 262d will be processed by an associated one of the processors 150 in the processor pool 110 (FIG. 3). For example, the frame 262a will be processed by the processor 150(1) (FIG. 3), and subsequent frame 262b will be processed by the processor 150(2). Subsequent frame 262c will be processed by the processor 150(1). Subsequent frame 262d will be processed by the processor 150(2). The frame 262b is temporally interleaved with the frames 262a and 262c, while the frame 262c is temporally interleaved with the frames 262b and 262d. Temporal interleaving may involve, for example, the use of additional buffers in hardware, or additional memory areas for a software-based embodiment to temporarily store video frames prior to processing by an assigned processor 150 in the processor pool 110.

A higher resolution video stream 270 can also be separated (or decomposed) into, for example, multiple lower resolution video streams based on temporal region, as shown in FIG. 2A. Each frame 262a, 262b, 262c, and 262d will be processed by an associated one of the processors 150 in the processor pool 110 (FIG. 3). For example, consecutive frames 262a and 262b will be processed by the processor 150(1) (FIG. 3), where the frames 262a and 262b are defined as being in the same temporal region. Consecutive frames 262c and 262d will be processed by the processor 150(2) (FIG. 3), where the frames 262c and 262d are defined as being in the same temporal region. The number of consecutive frames in a temporal region may vary. Additional buffers in hardware or additional memory areas for a software-based embodiment may be used to separate frames based on temporal region.

A higher resolution video stream can also be decomposed into multiple lower resolution video streams based on a combination of spatial and temporal decomposition, as shown symbolically shown in block 280 and as further illustrated in FIGS. 2B, 2C, 2D, and 2E.

FIG. 2B is a block diagram showing an example of a method of decomposing a video stream by a combination of spatial interleaving and temporal interleaving, in accordance with an embodiment of the invention. Assume, for example, that a higher resolution video stream 275 includes multiple video frames 276a, 276b, 276c, and 276d. The number of video frames may vary. Each video frame 276a-276d can be decomposed (by video decomposer 105) into multiple lower resolution component video streams by a combination of spatial interleaving and temporal interleaving. The number of lower resolution component video streams may vary. The number of lower resolution component video streams may vary. Each component video stream still shows the entire picture, but has a coarser appearance. For example, one component video stream may include particular pixel values at coordinates (i,j) of a frame, while another component video stream may include other particular pixel values at other coordinates of the same frame. In the example of FIG. 2B, the frame 277a of a component video stream includes pixel values at coordinates labeled as “1” of frame 276a of video stream 275, where each coordinate “1” has different (i,j) values. The frame 277b includes pixel values at coordinates labeled as “2” of frame 276a, where each coordinate “2” has different (i,j) values. The frame 277c includes pixel values at coordinates labeled as “3” of frame 276a, where each coordinate “3” has different (i,j) values. The frame 277d includes pixel values at coordinates labeled as “4” of frame 276a, where each coordinate “4” has different (i,j) values. Subsequent frames at subsequent time(s) t are also decomposed in the same manner. For example, subsequent frame 276b of the higher resolution video stream 275 can be decomposed (by video decomposer 105) into the component video stream frames 278a, 278b, 278c, and 278d in the same manner as described above. Subsequent frame 276c of the higher resolution video stream 275 can be decomposed into the component video stream frames 279a, 279b, 279c, and 279d in the same manner as described above. Subsequent frame 276d of the higher resolution video stream 275 can be decomposed into the component video stream frames 281a, 281b, 281c, and 281d in the same manner as described above.

In one embodiment, the component video stream frames 277a, 277b, 277c, and 277d may be processed by a first group of processors 150 formed by, for example, 150(1), 150(2), 150(3), and 150(4) in the processor pool 110 (FIG. 3). The component video stream frames 278a, 278b, 278c, and 278d decomposed from frame 276b may be processed by a second group of processors 150 in the processor pool 110. The component video stream frames 279a, 279b, 279c, and 279d decomposed from frame 276c may be processed by the first group of processors 150(1)-150(4) in the processor pool 110. The component video stream frames 281a, 281b, 281c, and 281d decomposed from frame 276d may be processed by the second group of processors in the processor pool 110.

The frame 276b is temporally interleaved with the frames 276a and 276c, while the frame 276c is temporally interleaved with the frames 276b and 276d. The combination of spatial interleaving and temporal interleaving may involve, for example, the use of additional buffers in hardware, or additional memory areas for a software-based embodiment.

FIG. 2C is a block diagram showing an example of a method of decomposing a video stream by a combination of spatial interleaving and temporal region based decomposition, in accordance with an embodiment of the invention. Assume, for example, that a higher resolution video stream 282 includes multiple video frames 283a, 283b, 283c, and 283d. The number of video frames may vary. Each video frame 283a-283d can be decomposed into multiple lower resolution component video streams by a combination of spatial interleaving and temporal region based interleaving. The number of lower resolution component video streams may vary.

In the example of FIG. 2C, the frame 283a is decomposed into multiple lower resolution component video stream frames 284a, 284b, 284c, and 284d. Each component video stream frame 284 still shows the entire picture, but has a coarser appearance. For example, the frame 283a may be decomposed into multiple component video stream frames 284a, 284b, 284c, and 284d, where each component video stream frame 284 includes particular pixel values at a defined frame region. In the example of FIG. 2C, the component video stream frame 284a includes pixel values at coordinates labeled as “1” in a spatial region of frame 283a of video stream 282. The size and or shape of a spatial region in a frame of video stream 282 may vary. The component video stream frame 284b includes pixel values at coordinates labeled as “2” in another spatial region of frame 283a of video stream 282. The component video stream frame 284c includes pixel values at coordinates labeled as “3” in another spatial region of frame 283a of video stream 282. The component video stream frame 284d includes pixel values at coordinates labeled as “4” in another spatial region of frame 283a of video stream 282. Subsequent frames at subsequent time(s) t are also decomposed in the same manner.

In one embodiment, the component video stream frames 284a, 284b, 284c, and 284d may be processed by a first group of processors 150 formed by, for example, 150(1), 150(2), 150(3), and 150(4) in the processor pool 110 (FIG. 3). The video decomposer 105 (FIG. 1) may perform the video decomposition steps described herein. The component video stream frames 285a, 285b, 285c, and 285d decomposed from frame 283b may be processed by the first group of processors 150(1)-150(4) in the processor pool 110. The component video stream frames 286a, 286b, 286c, and 286d decomposed from frame 283c may be processed by a second group of processors 150 in the processor pool 110. The component video stream frames 287a, 287b, 287c, and 287d decomposed from frame 283d may be processed by the second group of processors in the processor pool 110.

In the example of FIG. 2C, consecutive frames 283a and 283b will be processed by the first group of processors 150 in pool 110 (FIG. 3), where the frames 283a and 283b are defined as being in the same temporal region. Consecutive frames 283c and 283d will be processed by the second group of processors 150 in pool 110, where the frames 283c and 283d are defined as being in the same temporal region. The number of consecutive frames in a temporal region may vary. Additional buffers in hardware or additional memory areas for a software-based embodiment may be used to separate frames based on temporal region.

FIG. 2D is a block diagram showing an example of a method of decomposing a video stream by a combination of spatial region based decomposition and temporal interleaving, in accordance with an embodiment of the invention. Assume, for example, that a higher resolution video stream 287 includes frames 288a, 288b, 288c, and 288d. The frame 288a may be decomposed, for example, into multiple component video stream frames 289a, 289b, 289c, and 289d, where each component video stream frame 289 includes particular pixel values at a defined frame region. In the example of FIG. 2D, the component video stream frame 289a includes pixel values at coordinates labeled as “1” in a spatial region of frame 288a of video stream 287. The size and or shape of a spatial region in a frame of video stream 287 may vary. The component video stream frame 289b includes pixel values at coordinates labeled as “2” in another spatial region of frame 288a of video stream 287. The component video stream frame 289c includes pixel values at coordinates labeled as “3” in another spatial region of frame 288a of video stream 287. The component video stream frame 289d includes pixel values at coordinates labeled as “4”, in another spatial region of frame 288a of video stream 287. Subsequent frames at subsequent time(s) t are also decomposed in the same manner.

In one embodiment, the component video stream frames 289a, 289b, 289c, and 289d may be processed by a first group of processors 150 formed by, for example, 150(1), 150(2), 150(3), and 150(4) in the processor pool 110 (FIG. 3). The video decomposer 105 (FIG. 1) may perform the video decomposition steps described herein. The component video stream frames 290a, 290b, 290c, and 290d decomposed from frame 288b may be processed by a second group of processors 150 in the processor pool 110. The component video stream frames 291a, 291b, 291c, and 291d decomposed from frame 288c may be processed by the first group of processors 150 in the processor pool 110. The component video stream frames 292a, 292b, 292c, and 292d decomposed from frame 288d may be processed by the second group of processors 150 in the processor pool 110.

The frame 288b is temporally interleaved with the frames 288a and 288c, while the frame 288c is temporally interleaved with the frames 288b and 28d. The combination of spatial region based and temporal interleaved decomposition may involve, for example, the use of additional buffers in hardware, or additional memory areas for a software-based embodiment.

FIG. 2E is a block diagram showing an example of a method of decomposing a video stream by a combination of spatial region based decomposition and temporal region based decomposition, in accordance with an embodiment of the invention. Assume, for example, that a higher resolution video stream 293 includes frames 294a, 294b, 294c, and 294d. The frame 294a may be decomposed, for example, into multiple component video stream frames 295a, 295b, 295c, and 295d, where each component video stream frame 295 includes particular pixel values at a defined frame region. In the example of FIG. 2E, the component video stream frame 295a includes pixel values at coordinates labeled as “1” in a spatial region of frame 294a of video stream 293. The size and or shape of a spatial region in a frame of video stream 293 may vary. The component video stream frame 295b includes pixel values at coordinates labeled as “2” in another spatial region of frame 294a of video stream 293. The component video stream frame 295c includes pixel values at coordinates labeled as “3” in another spatial region of frame 294a of video stream 293. The component video stream frame 295d includes pixel values at coordinates labeled as “4” in another spatial region of frame 294a of video stream 293. Subsequent frames at subsequent time(s) t are also decomposed in the same manner.

In one embodiment, the component video stream frames 295a, 295b, 295c, and 295d may be processed by a first group of processors 150 formed by, for example, 150(1), 150(2), 150(3), and 150(4) in the processor pool 110 (FIG. 3). The video decomposer 105 (FIG. 1) may perform the video decomposition steps described herein. The component video stream frames 296a, 296b, 296c, and 296d decomposed from frame 294b may be processed by the first group of processors 150 in the processor pool 110. The component video stream frames 297a, 297b, 297c, and 297d decomposed from frame 294c may be processed by a second group of processors 150 in the processor pool 110. The component video stream frames 298a, 298b, 298c, and 298d decomposed from frame 294d may be processed by the second group of processors 150 in the processor pool 110.

In the example of FIG. 2E, consecutive frames 294a and 294b will be processed by the first group of processors 150 in pool 110 (FIG. 3), where the frames 294a and 294b are defined as being in the same temporal region. Consecutive frames 294c and 294d will be processed by the second group of processors 150 in pool 110, where the frames 294c and 294d are defined as being in the same temporal region. The number of consecutive frames in a temporal region may vary. Additional buffers in hardware or additional memory areas for a software-based embodiment may be used to separate frames based on temporal region.

FIG. 3 is a block diagram that illustrates additional functions of an embodiment of the transmit-side components (formed by the video decomposer 105, processor pool 110, and partition compensation circuit and marker stage 120). In one embodiment, the video decomposer 105 includes a mode select capability or switch stage 300 for optimized operation. The mode selection is based on the selected bandwidth that is based on some system control input 306 or based on channel feedback that is received from the returned channel (in the transmission media 165) when available. The input for selecting bandwidth can be performed dynamically. The method of dynamically providing input to determine the distribution of bit streams may be performed based upon the system control input 306. In an embodiment, the system control input 306 is based on user inputs or system conditions, e.g., system channel assignment, storage size, or desirable video quality and bit rate trade-offs. Additional details on the distribution of bit stream based on the channel feedback are as follows. In real time communications, the channel conditions varies with time, e.g., the Internet might experience congestion during a certain period of time. When this happen, the feedback about channel status can be used to control the selecting of multiple encoded bit streams to create the final bit stream.

In an alternative embodiment, some initial conditions can be passed to the multiple processors 150(1), 150(2), 150(3), . . . , . . . , . . . 150(N)(where N=integer) by use of external control signals, or internally by connecting the multiple processors 150 to a common bus. The initial conditions may include, for example, the following. The starting point for the motion search processing in each processor can be initiated based the previous motion vector, or the motion vector calculated from the neighboring processors.

In one embodiment, the partition compensation circuit and marker stage 120 generates compensation bit streams due to the disclosed decomposing scheme. In addition, the stage 120 controls the rate, and hence the scalability, of the distributed video. The stage 120 permits parallel-to-serial data transmission. For example, the stage 120 can select one processor output for transmission (by use of multiplexing), or the stage 120 can average four component video streams and then transmit the averaged stream, depending on the channel conditions and input request.

The stage 120 can also insert suitable markers and error resilience (ER) information for use in retrieving data at the receiver-side. The video composer 135 (FIG. 1) may perform partition compensation on the video frames in order to smooth out the boundary conditions that were formed due to the partitioning of the frames into sub-frames. The video composer 135 may, for example, average the pixel values along boundaries of sub-frames in order to smooth out the boundary conditions.

In another embodiment, a partition compensation scheme of FIG. 4 may be used to smooth out the boundary conditions. Stage 400 is used to determine the difference between the original video signal 140 (prior to being received by the video composer 135) and the video 402 that is locally reconstructed by the local video composer 435 (the local video composer 435 is in the transmit-side or apparatus 100). Thus, the stage 400 can determine the information that was lost as a result of video partitioning. The output of stage 400 is then processed by a smoothing and Direct Cosine Transform (DCT) stage 405, resulting in the generation of the partition compensation bit stream 410 to feed into the mapping/multiplexer/select stage 120. The mapping/multiplexing/select stage 120 will then combine the encoded bit streams 402 from stage 110 and the compensation bit stream 410 to create the final data stream 510 for transmission across the communication channels 165 or outputs the data to the video storage 160.

The local video composer 435 performs the same function as the receive-end video composer 135. However, they are two separate units, one (435) on transmit-end and one (135) on receive-end.

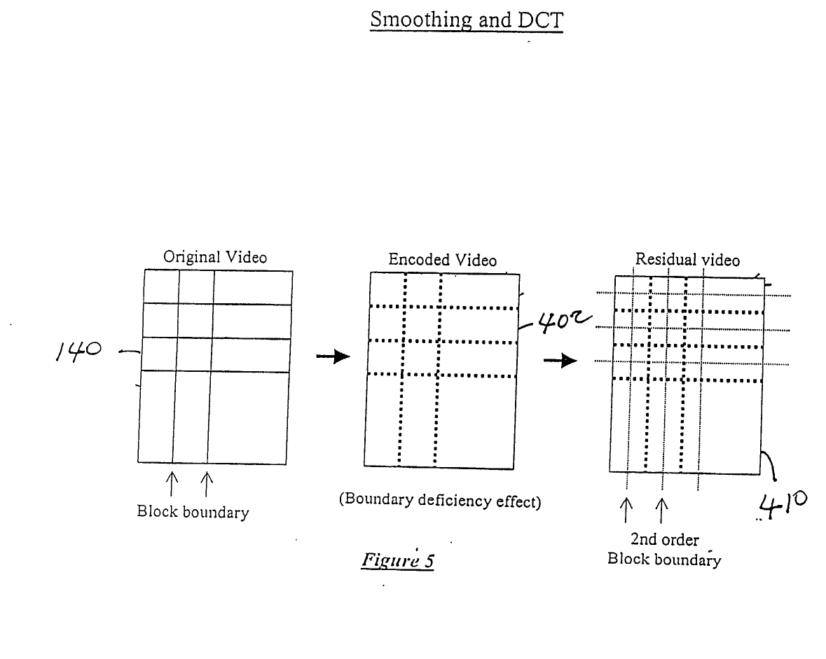

FIG. 5 are diagrams illustrating smoothing and DCT methods, in accordance with a specific embodiment of the invention. Due to the block-based compression technique that is often employed, there may be a need for smoothing of the block boundary/edge effect to maintain the integrity of the video quality. In setting the block boundary of the residual video frame 410 (i.e., the difference between the original video 140 and the locally reconstructed video frame 402 from the symmetric multi-processor pool 110 outputs) for the second-time DCT performed by the receive-stage 125 (on the receiver-side) (FIG. 1), the pixel position is shifted by a fixed number (e.g., 4 pixels). The purpose of the shifted pixel is to smooth the boundary blocks so that the errors due to the first block-based DCT (performed in the transmit-stage 120 in FIG. 1) or the frame decomposer 105 can be effectively represented. The second-time DCT output data from the receive-stage 125 will be stored or distributed along with the decomposed bit streams 175 (FIG. 1).

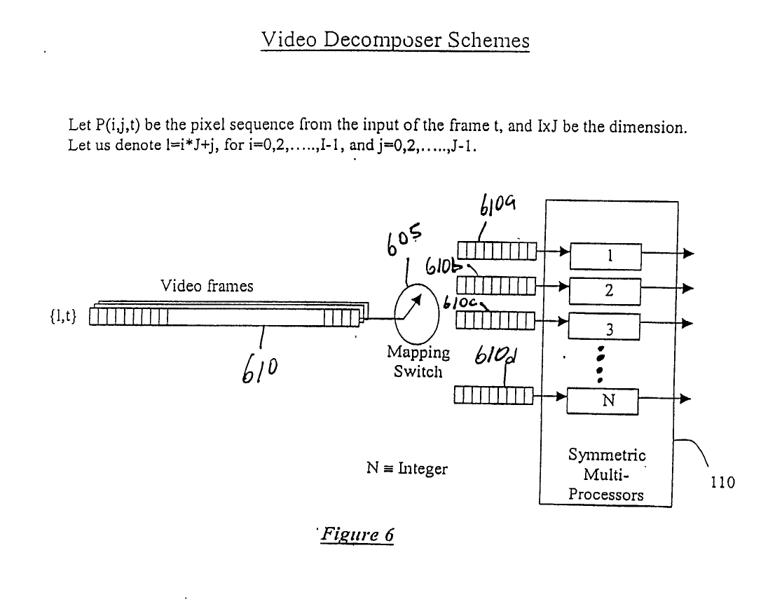

FIG. 6 is a diagram illustrating one embodiment of a method of decomposing a video. In one embodiment, a mapping switch 605 may be implemented and is used to assign a video component video stream (e.g., one of the components 610a to 610d that has been partitioned from a video frame 610) for processing to one of the processors 150(1) to 150(N) in the processor pool 110. In the example of FIG. 6, assume that P(i,j,t) is the pixel sequence from the input of the frame t, and I×J is the dimension. Additionally, let I=i*J+j, for i=0,2, . . . , I−1, and j=0,2, . . . , J−1. The mapping switch 605 determines the assigned processor based on the pixel coordinates P(i,j,t) of the partitioned video component, where (i,j) are the dimension coordinates and t is the time for a particular frame.

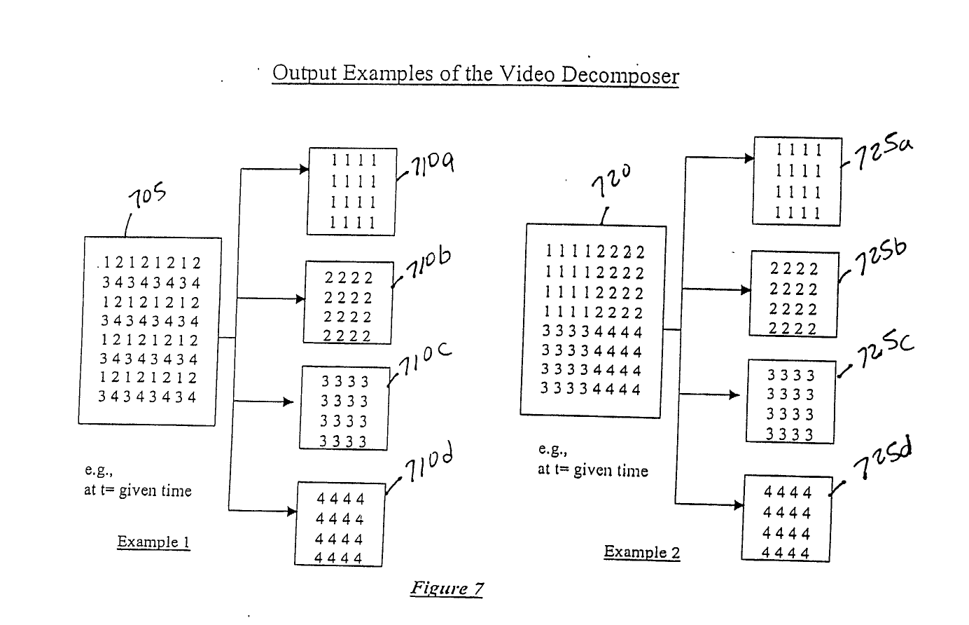

FIG. 7 are block diagrams of video frames that are partitioned into lower resolution component frames at a given time t, in accordance with a specific embodiment of the invention. FIG. 7 shows a method of partitioning based on spatial interleaving (example 1) and a method of partitioning based on spatial region (example 2). The frame 705 is partitioned into lower resolution component frames 710a to 710d, while the frame 720 is partitioned into lower resolution component frames 725a to 725d.

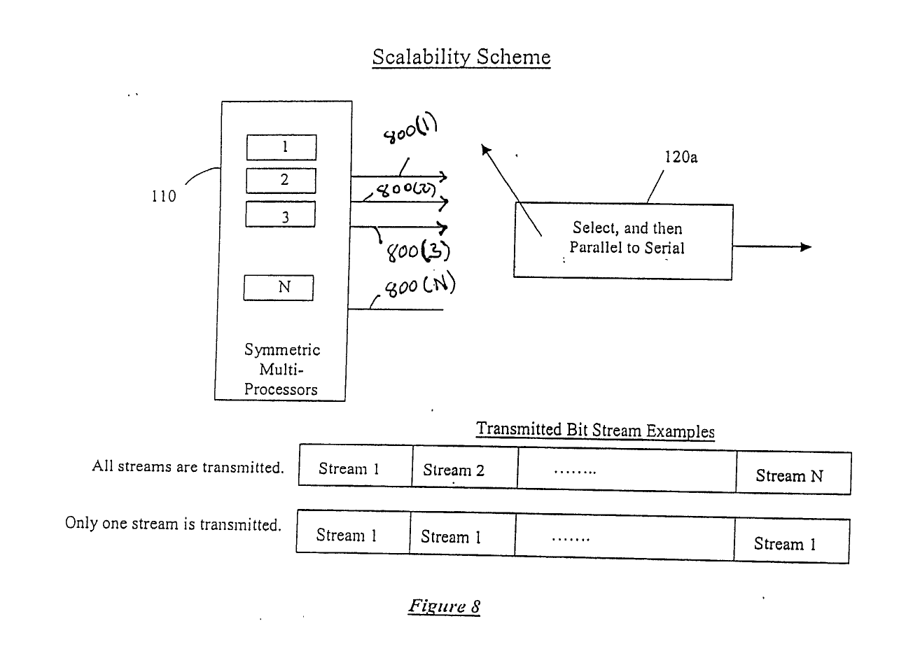

FIG. 8 is a block diagram of some of the transmit-side stages shown for the purpose of describing the scalability scheme of an embodiment of the invention. The component video streams generated from the processors 150(1) to 150(N) in the processor pool 110 may be selected by a selection circuit 120a in the stage 120 in order to achieve a parallel-to-serial transmission of the component video streams 800(1), 800(2), 800(3), . . . , . . . , 800(N). FIG. 8 also shows some examples of transmitted bit streams from the transmission-side stages. For larger bandwidth video signals, at least some of the processors 150 (in pool 110) will process an associated component video stream (Stream 1, Stream 2, . . . Stream N) in the video. Stream 1, Stream 2, . . . , . . . , are the bit stream for component video stream 800(1), 800(2), . . . , . . . , 800(N). For smaller bandwidth video signals, one processor 150 in the pool 110 may process a single transmitted stream (Stream 1).

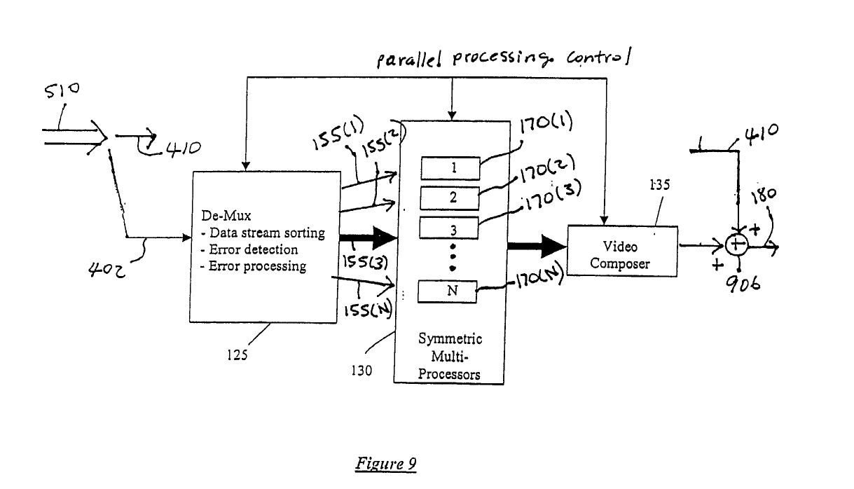

FIG. 9 is block diagram illustrating additional details and functions of the receiver-side stages (formed by de-multiplexer and de-marker stage 125, processor pool 130 and video composer 135), in embodiment of the present invention. The de-multiplexer and de-marker stage 125 performs data stream sorting so that each component video stream 155(1), 155(2), 155(3), . . . , . . . , 155(N) is transmitted to an assigned processor 170(1)-170(N) in processor pool 130 for de-compression functions. The stage 125 may also perform error detection to detect for errors in the component video streams 155(1)-155(N). The stage 125 may also perform error processing to compensate for errors in the component video streams 155(1)-155(N).

In an embodiment, the processors 170(1)-170(N) in the processor pool 130 may perform decompression functions as described above on the component video streams 155(1)-155(N). Additionally, the processor pool 130 permits synchronization of the processed signals (i.e., synchronization of the received component video streams 155(1)-155(N)). Appropriate error processing may also be performed in the processor pool 130 to compensate for particular errors in the component video streams 155(1)-155(N).

The video composer 135 composes (906) the low bit-rate, low resolution/low frame-rate component video streams 155(1)-155(N) together with the partition compensation bit stream 410 (FIG. 4) into a single high quality, high resolution/high frame-rate recovered video stream 180.

In one embodiment, the video composer 135 may also refine the boundary/edge effect due to spatial/temporal partition, depending on how the video frame was decomposed at the video decomposer stage 105. Thus, the video composer 135 can refine the sub-frame edges, depending on how the video signal was decomposed during the start of the transmission at the video decomposer 105 (FIG. 1). If the content format of the video signal is simpler, then basic video composing may be performed.

In one embodiment, the video composer 135 may also perform error compensation for the video signals.

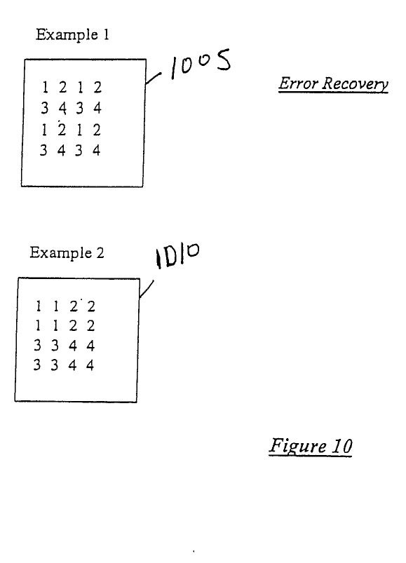

FIG. 10 are block diagrams 1005 and 1010 illustrating examples of error recovery methods according to at least a specific embodiment of the invention. The de-multiplexer in stage 125 (FIG. 1) will detect pixel locations (in the component video streams 155a-155c) having erroneous bits. The affected locations will be sent to the decoder/processors pool 130 and video composer 135 to perform a method of error recovery, depending on the partition formats. In Example 1 in FIG. 10, the video processors 170 (in pool 130) do not process the pixels that are flagged as erroneous, but the receive-side stage 125 will instruct the video composer 135 to perform error recovery by averaging pixels spatially adjacent to the erroneous pixels in neighboring component video streams 155 (e.g., neighboring component video streams 155a and 155b). In Example 2 in FIG. 10, the receive-side stage 125 will instruct the video processors 170 to perform error recovery by averaging the pixels temporally adjacent to the erroneous pixels in the same component video stream 155 and the video composer 135 will perform video data reconstruction. The de-multiplexer in the stage 125 (FIG. 1) will instruct the processors 170a-170b in the pool 130 to perform error recovery by averaging the adjacent pixels in the same component video stream 155 (e.g., component video stream 155a).

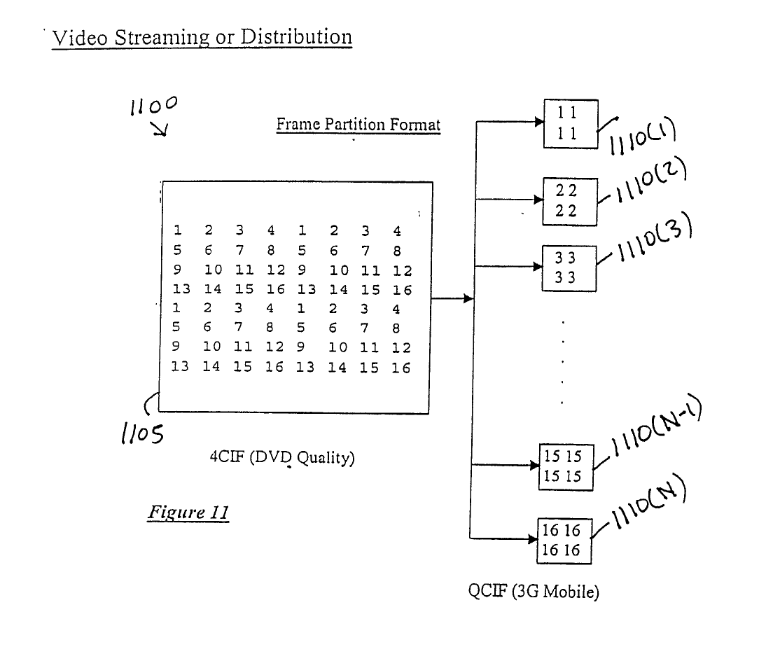

FIG. 11 is a block diagram illustrating a method 1100 of video streaming or distribution according to an embodiment of the invention. The method 1100 enables a truly scalable bit stream. Depending on the channel bandwidth (as determined by the requesting source), a portion of the high quality bit streams can be distributed in accordance with the input selection or the channel feedback, as described above with respect to FIG. 3. This reduced scaled bit stream includes the basic bit streams (from the symmetric processors 150a-150c), as well as the partition compensation bit stream 410 (from stage 405 in FIG. 4). In the example shown in FIG. 11, an original video frame 1105 is partitioned into 4×4 sub-frames 1110(1), 1110(2), 1110(3), . . . , . . . , 1110(N−1), and 1110(N) where N is an integer. A high quality bit stream 1105 can be created as the source and distributed to various applications such as from the 3G application with QCIF format to a digital video disc (DVD) quality with 4CIF format. As known to those skilled in the art, 3G is an ITU specification for the third generation of mobile communications technology (analog cellular was the first generation, and digital PCS the second generation). 3G will work over wireless air interfaces such as GSM, TDMA, and CDMA. QCIF (Quarter Common Intermediate Format) is a videoconferencing format that specifies data rates of 30 frames per second (fps), with each frame containing 144 lines and 176 pixels per line. This is one fourth the resolution of Full CIF. QCIF support is required by the ITU H.261 videoconferencing standard. 4CIF is 4 times the resolution of CIF. The support of 4CIF permits codec could to compete with other higher bit-rate video coding standards such as the MPEG standards.

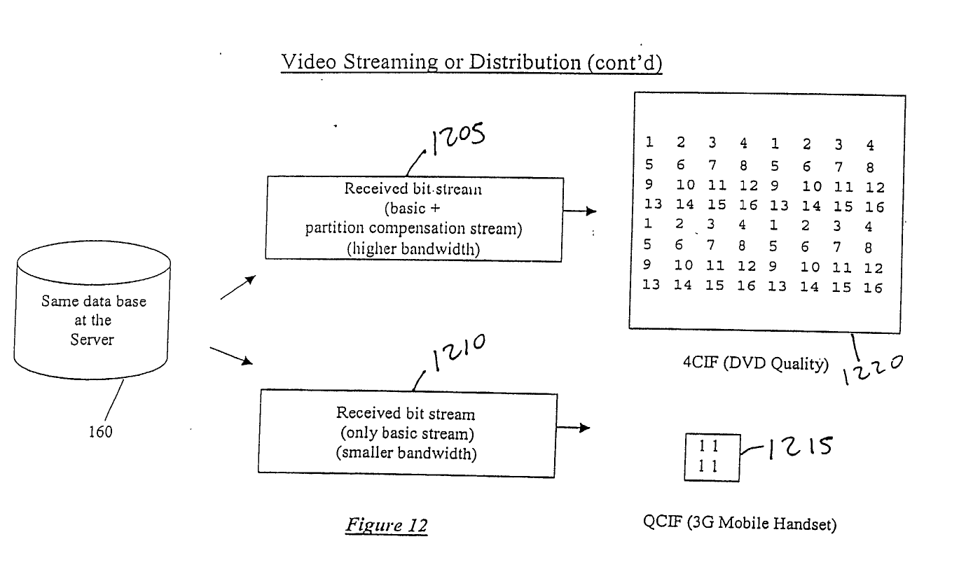

FIG. 12 is a block diagram showing functional aspects of the video streaming or distribution method of FIG. 11. A single source, such as data storage 160, may store bit streams for transmission to various bandwidth-dependent applications such as from the 3G application with QCIF format 1215 to a DVD quality with 4CIF format 1220. The bit stream 1205 transmitted to the DVD quality application may include the basic bit stream and a partition compensation bit stream 410, while the bit stream 1210 transmitted to the 3G application may include, for example, only the basic bit stream. The bit stream 1205 typically requires a higher bandwidth, while the bit stream 1210 typically requires a relatively smaller bandwidth.

FIG. 13 is a block diagram illustrating additional details of the stages in the transmit-side of the system 100 of FIG. 1, in accordance with an embodiment of the invention. In one embodiment, the video data 1305 is delivered from a digital video source 1300 to processors 150(1)-150(N). In one embodiment, the processors 150(1)-150(N) are video encoders. A decompose control block 1306 receives synchronization signals 1310 from the digital video source 1300. Based on the specified decomposition method (described above), the decompose control block 1306 can partition the video data 1305 into components 1305(1), 1305(2), . . . , . . . , 1305(N), and generate N sets of scan control signals (sc1, sc2, . . . , . . . , scN where N is an integer). The scan control signals sc1, sc2, . . . , . . . , scN controls the video encoder 150(1), 150(2), . . . , . . . , 150(N)), respectively. The marker 120b (in stage 120) marks information in the video streams, as previously discussed above.

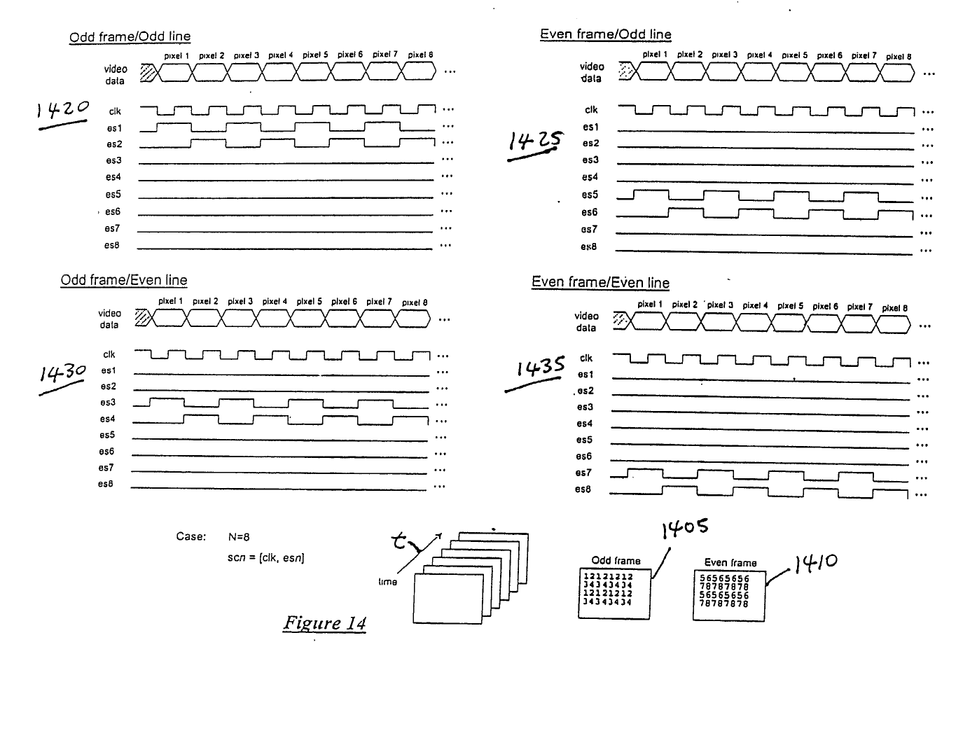

FIG. 14 shows various timing diagrams for odd video frame 1405 and even video frame 1410 that are processed in the video composer 105 of FIG. 1, in accordance with an embodiment of the invention. The timing diagrams in FIG. 14 is, for example, in the case where N=8 and the scan control signal scn=[clock clk, esn] where n==1, . . . , N=1, 2, 3, 4, 5, 6, 7, 8. Timing diagram 1420 illustrates the timing for an odd frame and odd line. Timing diagram 1425 illustrates the timing for an even frame and odd line. Timing diagram 1430 illustrates the timing for an odd frame and even line. Timing diagram 1435 illustrates the timing for an even frame and even line.

FIG. 15 is a block diagram illustrating additional details of the stages in the receive-side of the system of FIG. 1, in accordance with an embodiment of the invention. Each video decoder 170(1), 170(2), . . . , . . . , 170(N) sends their respective outputs 175(1), 175(2), . . . , . . . , 175(N) to an associated video buffer 1505(1), 1505(2), . . . , . . . , 1505(N) in the video composer 135. In an embodiment, the video composer includes one or more video assembles 1510(1), 1510(2), . . . , . . . , 1510(M) where M is an integer. Each video assembler 1510(1), 1510(2), . . . , . . . 1510(M) can recover a digital output 180(1), 180(2), . . . , . . . 180(M), respectively, to the required quality.

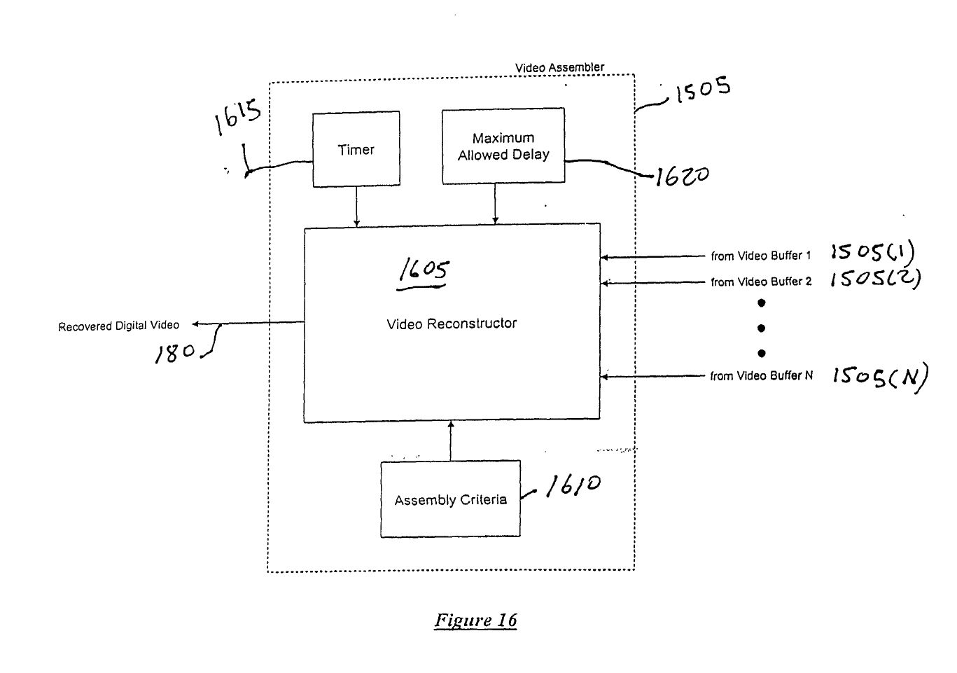

FIG. 16 is a block diagram of a video assembler 1505 for performing video reconstruction due to errors, in accordance with an embodiment of the invention. A stage 1620 generates a maximum allowed delay which is a programmable parameter specifying the tolerance in real-time video communication. A stage 1610 generates the assembly criteria which include required video resolution and frame rate. Based on the maximum allowed delay and the assembly criteria, the video reconstructor 1605 performs the necessary video processing, including prediction and scaling, to generate a desired digital video output 180. The time 1615 may be a standard timer for timing functions.

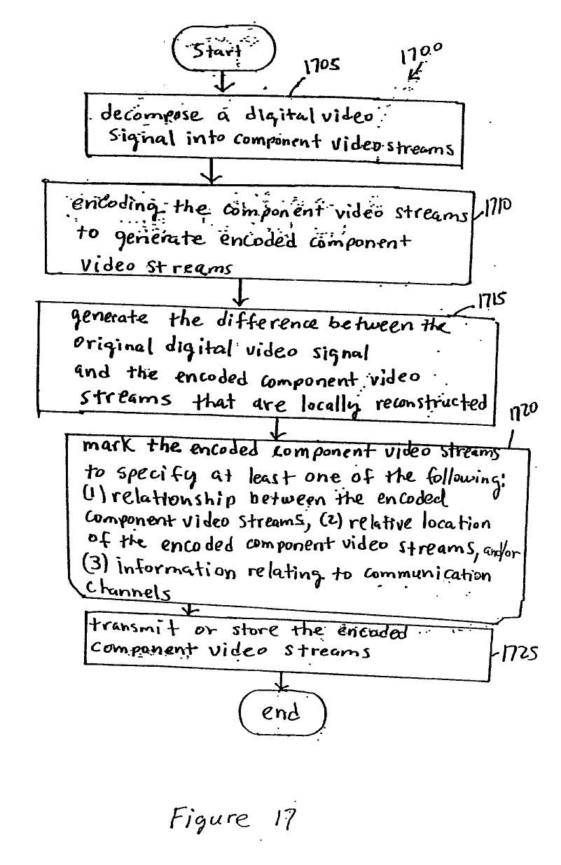

FIG. 17 is a flowchart illustrating a method 1700 of transmitting data, in accordance with an embodiment of the invention. A digital video signal (from a video source) is decomposed (1705) into component video streams. The component video streams are encoded (1710) to generate encoded component video streams. A difference is then generated (1715) between the original digital video signal and the encoded component video streams that are locally reconstructed. This difference (i.e., partition compensation bit stream) is a fine, but much reduced video information, that will be stored and/or distributed along with the encoded component video streams. Information is then marked (1720) in the encoded component video streams to specify at least one of the following: (1) the relationship between the encoded component video streams; (2) the relative location of encoded component video streams that are stored in video storage device 160; and/or (3) information relating to the communications channels 165 that transmit the encoded component video streams. The above-information as marked by the marker 120b (FIG. 13) permits the network-transmitted encoded component video streams or other network-transmitted data to be more error resilient, and this information can include error resilient information to make the video streams or other data to be more resilient to channel noise and interference.

The encoded component video streams can be stored in the storage device 160 or separately transmitted via a transmission media (e.g., communication channels 165), as shown in action (1725).

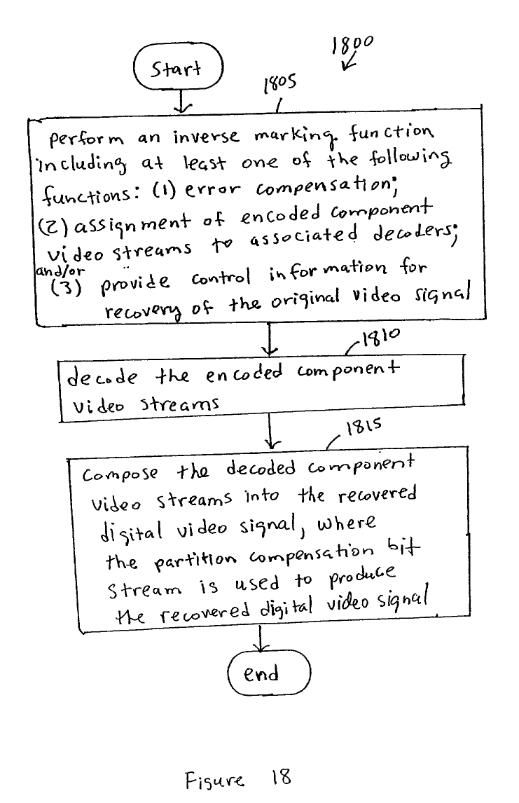

FIG. 18 is a flowchart illustrating a method 1800 of receiving data, in accordance with an embodiment of the invention. After the encoded component video streams (and the partition compensation bit stream) are received via communication channels, an inverse marking function is then performed (1805) on the encoded component video streams. This function includes at least one of the following: (1) performing error compensation functions; (2) assignment of the encoded component video streams to associated processors such as decoders; and/or (3) providing control information to the video composer 135 to recover the original video data, even if some component video streams are missing.

The encoded component video streams are then decoded (1810). The decoded component video streams are then composed into the recovered digital video stream. The decoded video component streams and the partition compensation bit stream may be combined to reproduce the original high resolution input video stream as the recovered digital video signal.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or actions will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus in a transmit-side stage in a video distribution system, comprising:
a video decomposer capable to partition a video stream into a plurality of component video streams;
a transmit-side processor pool capable to process the component video streams;
a partition compensation circuit capable to generate a partition compensation bit stream for distribution along with the compressed bit streams of the component video streams;
a marker stage capable to mark the compressed component video streams prior to storage or distribution to a transmission media; and
a selection circuit capable to transmit the component video streams for transmission across the transmission media or for storage in a storage device.

2. The apparatus of claim 1, wherein the transmit-side processor pool comprises:
a plurality of processors, each processor configured to encode an associated one of the component video streams.

3. The apparatus of claim 2, wherein the partition compensation bit stream comprises a difference between the video stream and locally reconstructed encoded component video streams.

4. The apparatus of claim 1, wherein the marker stage is configured to mark the encoded component video streams to specify at least one of: (1) the relationship between the encoded component video streams; (2) the relative location of encoded component video streams that are stored in a video storage device; and (3) information relating to a transmission media that transmit the encoded component video streams.

5. The apparatus of claim 1, wherein the marker stage permits the encoded component video streams to be more error resilient.

6. The apparatus of claim 1, wherein the video decomposer is configured to decompose the video stream by spatial interleaving.

7. The apparatus of claim 1, wherein the video decomposer is configured to decompose the video stream by spatial region based decomposition.

8. The apparatus of claim 1, wherein the video decomposer is configured to decompose the video stream by temporal interleaving.

9. The apparatus of claim 1, wherein the video decomposer is configured to decompose the video stream by temporal region based decomposition.

10. The apparatus of claim 1, wherein the video decomposer is configured to decompose the video stream by a combination of spatial interleaving and temporal interleaving.

11. The apparatus of claim 1, wherein the video decomposer is configured to decompose the video stream by a combination of spatial interleaving and temporal region based interleaving.

12. The apparatus of claim 1, wherein the video decomposer is configured to decompose the video stream by a combination of spatial region based decomposition and temporal interleaving.

13. The apparatus of claim 1, wherein the video decomposer is configured to decompose the video stream by a combination of spatial region based decomposition and temporal region based decomposition.

14. The apparatus of claim 1, wherein the video decomposer includes a mode select capability based on an input of a selected bandwidth.

15. The apparatus of claim 1, wherein the video decomposer includes a mode select capability based on channel feedback from the transmission media.

16. The apparatus of claim 1, wherein the selection circuit can output component video streams by parallel-to-serial transmission.

17. The apparatus of claim 1, wherein the selection circuit can output component video streams by averaging the output component video streams into an averaged stream.

18. An apparatus in receive-side stage in a video distribution system, comprising:
a de-multiplexer and de-marker stage capable to sort component video streams received from a transmission media;
a receive-side processor pool capable to process the component video streams; and
a video composer capable to re-construct original video stream from the component video streams and the partition compensation bit stream.

19. The apparatus of claim 18, wherein the receive-side processor pool comprises:
a plurality of processors, each processor configured to decode an associated one of the component video streams.

20. The apparatus of claim 19, wherein the video composer is configured to compose the decoded component video streams together with a partition compensation bit stream into a recovered video signal.

21. The apparatus of claim 19, wherein the video composer is configured to refine edges of sub-frames in the decoded component video streams.

22. The apparatus of claim 19, wherein the de-multiplexer and de-marker stage is configured to instruct the video composer to perform error recovery by averaging pixels spatially adjacent to erroneous pixels in neighboring component video streams.

23. The apparatus of claim 19, wherein the de-multiplexer and de-marker stage is configured to instruct the processors to perform error recovery by averaging the pixels temporally adjacent to the erroneous pixels in the same component video stream.

24. The apparatus of claim 18, wherein the de-multiplexer and de-marker stage is configured to performing an inverse marking function that includes at least one of the following: (1) performing error compensation functions; (2) assigning the encoded component video streams to an associated processor for decoding; and (3) providing control information to the video composer to recover the original video signal, even if some component video streams are missing.

25. An apparatus for distributing bit streams, comprising:
a single video source capable to generate component video streams and a partition compensation stream; and
a processor capable to select a subset of the component video streams fulfilling at least some of quality, resolution, frame rate requested, and channel bandwidth, error, delay characteristics.

26. The apparatus of claim 25, wherein the processor is included in a pool of processors, where each processor is configured to encode an associated one of the component video streams.

27. The apparatus of claim 26, wherein the partition compensation bit stream comprises a difference between an original video stream and locally reconstructed encoded component video streams.

28. The apparatus of claim 26, further comprising:
a marker stage configured to mark the encoded component video streams to specify at least one of: (1) the relationship between the encoded component video streams; (2) the relative location of encoded component video streams that are stored in a video storage device; and (3) information relating to a transmission media that transmit the encoded component video streams.

29. The apparatus of claim 28, wherein the marker stage permits the encoded component video streams to be more error resilient.

30. The apparatus of claim 26, further comprising:
a video decomposer configured to decompose the video stream by spatial interleaving.

31. The apparatus of claim 30, wherein the video decomposer is configured to decompose the video stream by spatial region based decomposition.

32. The apparatus of claim 30, wherein the video decomposer is configured to decompose the video stream by temporal interleaving.

33. The apparatus of claim 30, wherein the video decomposer is configured to decompose the video stream by temporal region based decomposition.

34. The apparatus of claim 30, wherein the video decomposer is configured to decompose the video stream by a combination of spatial interleaving and temporal interleaving.

35. The apparatus of claim 30, wherein the video decomposer is configured to decompose the video stream by a combination of spatial interleaving and temporal region based interleaving.

36. The apparatus of claim 30, wherein the video decomposer is configured to decompose the video stream by a combination of spatial region based decomposition and temporal interleaving.

37. The apparatus of claim 30, wherein the video decomposer is configured to decompose the video stream by a combination of spatial region based decomposition and temporal region based decomposition.

38. The apparatus of claim 30, wherein the video decomposer includes a mode select capability based on an input of a selected bandwidth.

39. The apparatus of claim 30, wherein the video decomposer includes a mode select capability based on channel feedback from the transmission media.

40. The apparatus of claim 25, further comprising:
a selection circuit configured to output component video streams by parallel-to-serial transmission.

41. The apparatus of claim 25, further comprising:
a selection circuit configured to output component video streams by averaging the output component video streams into an averaged stream.

42. An apparatus for distributing data, comprising:
a pool of symmetrical processors, including a transmit-side processor pool capable to encode parallel component video streams and a receive-side processor pool capable to decode parallel component video streams; and
parallel processing control units, including a transmit-side parallel processing control unit and a receive-side parallel processing control unit, each unit capable to generate processor control signals and settings, based on at least some of video encoding or decoding requirements, status of video streams, and status of multiple processors in the pool, to facilitate the coordination among multiple processors in the pool to effectively encode or decode the video streams to achieve high quality and high performance targets.

43. The apparatus of claim 42, wherein the transmit-side processor pool comprises:
a plurality of processors, each processor configured to encode an associated one of the component video streams.

44. The apparatus of claim 42, wherein the transmit-side parallel processing control unit is capable to generate a partition compensation bit stream.

45. The apparatus of claim 42, wherein the transmit-side parallel processing control unit is configured to mark the encoded component video streams to specify at least one of: (1) the relationship between the encoded component video streams; (2) the relative location of encoded component video streams that are stored in video storage device; and (3) information relating to a transmission media that transmit the encoded component video streams.

46. The apparatus of claim 42, wherein the transmit-side parallel processing control unit permits the encoded component video streams to be more error resilient.

47. The apparatus of claim 42, further comprising:
a video decomposer configured to decompose the video stream by spatial interleaving.

48. The apparatus of claim 47, wherein the video decomposer is configured to decompose the video stream by spatial region based decomposition.

49. The apparatus of claim 47, wherein the video decomposer is configured to decompose the video stream by temporal interleaving.

50. The apparatus of claim 47, wherein the video decomposer is configured to decompose the video stream by temporal region based decomposition.

51. The apparatus of claim 47, wherein the video decomposer is configured to decompose the video stream by a combination of spatial interleaving and temporal interleaving.

52. The apparatus of claim 47, wherein the video decomposer is configured to decompose the video stream by a combination of spatial interleaving and temporal region based interleaving.

53. The apparatus of claim 47, wherein the video decomposer is configured to decompose the video stream by a combination of spatial region based decomposition and temporal interleaving.

54. The apparatus of claim 47, wherein the video decomposer is configured to decompose the video stream by a combination of spatial region based decomposition and temporal region based decomposition.

55. The apparatus of claim 47, wherein the video decomposer includes a mode select capability based on an input of a selected bandwidth.

56. The apparatus of claim 47, wherein the video decomposer includes a mode select capability based on channel feedback from the transmission media.

57. The apparatus of claim 42, further comprising:
a selection circuit configured to output component video streams by parallel-to-serial transmission.

58. The apparatus of claim 42, further comprising:
a selection circuit can output component video streams by averaging the output component video streams into an averaged stream.

59. The apparatus of claim 42, wherein the receive-side processor pool comprises:
a plurality of processors, each processor configured to decode an associated one of the component video streams.

60. The apparatus of claim 42, further comprising:
a video composer is configured to compose the decoded component video streams together with a partition compensation bit stream into a recovered video signal.

61. The apparatus of claim 60, wherein the video composer is configured to refine edges of sub-frames in the decoded component video streams.

62. The apparatus of claim 60, wherein the receive-side processor control unit is configured to instruct the video composer to perform error recovery by averaging pixels spatially adjacent to erroneous pixels in neighboring component video streams.

63. The apparatus of claim 60, wherein the receive-side processor control unit is configured to instruct the processors to perform error recovery by averaging the pixels temporally adjacent to the erroneous pixels in the same component video stream.

64. The apparatus of claim 42, wherein the receive-side processor control unit is configured to performing an inverse marking function that includes at least one of the following: (1) performing error compensation functions; (2) assigning the encoded component video streams to an associated processor for decoding; and (3) providing control information to the video composer to recover the original video signal, even if some component video streams are missing.

65. A method of transmitting data, comprising:
decomposing a digital video signal into component video streams;
encoding the component video streams to generate encoded component video streams;
generating a difference between the original digital video signal and the encoded component video streams that are locally reconstructed;
marking the encoded component video streams to specify at least one of the following: (1) the relationship between the encoded component video streams; (2) the relative location of encoded component video streams that are stored in video storage device; and (3) information relating to a transmission media that transmit the encoded component video streams; and
permitting the encoded component video streams to be stored or separately transmitted via a transmission media.

66. The method 65 wherein the decomposing the digital video signal comprises: decomposing the video signal by spatial interleaving.

67. The method 65 wherein the decomposing the digital video signal comprises: decomposing the video signal by spatial region based decomposition.

68. The method 65 wherein the decomposing the digital video signal comprises: decomposing the video signal by temporal interleaving.

69. The method 65 wherein the decomposing the digital video signal comprises: decomposing the video signal by temporal region based decomposition.

70. The method 65 wherein the decomposing the digital video signal comprises: decomposing the video signal by a combination of spatial interleaving and temporal interleaving.

71. The method 65 wherein the decomposing the digital video signal comprises: decomposing the video signal by a combination of spatial interleaving and temporal region based interleaving.

72. The method 65 wherein the decomposing the digital video signal comprises: decomposing the video signal by a combination of spatial region based decomposition and temporal interleaving.

73. The method 65 wherein the decomposing the digital video signal comprises: decomposing the video signal by a combination of spatial region based decomposition and temporal region based decomposition.

74. A method of receiving data, comprising:
receiving encoded component video streams via a transmission media;
performing an inverse marking function that includes at least one of the following: (1) performing error compensation functions; (2) assigning the encoded component video streams to an associated processor for decoding; and (3) providing control information to a video composer to recover the original video data, even if some component video streams are missing;
decoding the encoded component video streams; and
composing the decoded component video streams into the recovered digital video stream.

75. The method of claim 74, wherein the composing of the decoded component video streams comprises:
composing the decoded component video streams together with a partition compensation bit stream into the recovered video signal.

76. The method of claim 74, wherein the composing of the decoded component video streams comprises:
refining edges of sub-frames in the decoded component video streams.

77. The method of claim 74, further comprising:
instructing a video composer to perform error recovery by averaging pixels spatially adjacent to erroneous pixels in neighboring component video streams.

78. The method of claim 74, further comprising:
instructing processors to perform error recovery by averaging the pixels temporally adjacent to the erroneous pixels in the same component video stream.

79. An apparatus for transmitting data, comprising:
means for decomposing a digital video signal into component video streams;
coupled to the decomposing means, means for encoding the component video streams to generate encoded component video streams;
coupled to the encoding means, means for generating a difference between the original digital video signal and the encoded component video streams that are locally reconstructed;
coupled to the generating means, means for marking the encoded component video streams to specify at least one of the following: (1) the relationship between the encoded component video streams; (2) the relative location of encoded component video streams that are stored in video storage device; and (3) information relating to a transmission media that transmit the encoded component video streams; and
coupled to the marking means, means for permitting the encoded component video streams to be stored or separately transmitted via a transmission media.

80. An apparatus for of receiving data, comprising:
means for receiving encoded component video streams via a transmission media;
coupled to the receiving means, means for performing an inverse marking function that includes at least one of the following: (1) performing error compensation functions; (2) assigning the encoded component video streams to an associated processor for decoding; and (3) providing control information to a video composer to recover the original video data, even if some component video streams are missing;
coupled to the performing means, means for decoding the encoded component video streams; and
coupled to the decoding means, means for composing the decoded component video streams into the recovered digital video stream.
